(19) United States
(12) Patent Application Publication
(10) Pub. No.: US 2004/0189009 A1
(43) Pub. Date: Sep. 30, 2004

(54) Electrical energy generation system

(76) Inventor: Thomas P. Galich, Laguna Hills, CA (US)

Correspondence Address: Kit M. Stetina, STETINA BRUNDA GARRED & BRUCKER, 75 Enterprise, Suite 250, Also Viejo, CA, 92656, US

(21) Appl. No.: 10/401,175

(22) Filed: Mar. 27, 2003

(51) Int. Cl. H02P 9/04; F03B 13/00

(52) U.S. Cl. 290/54

(57) ABSTRACT

An electricity generation system configured for generating electrical energy from potential energy comprises a support frame, an actuator, a counterweight, a hydraulic assembly, a multiple pulley system and an elevating motor. The hydraulic assembly includes an accumulator, a hydraulic turbine and a generator. The counterweight is attached to the piston rod. The elevating motor is configured to alternately raise and lower the counterweight with the aid of the multiple pulley system, disposed between the counterweight and the support frame, in order to reciprocate the piston rod within the interior chamber such that the hydraulic fluid may be circulated through the hydraulic assembly. The accumulator receives and pressurizes hydraulic fluid from the actuator and releases it to the hydraulic turbine such that the hydraulic turbine may be rotated. The generator is rotatably driven by the hydraulic turbine and converts its rotational motion into electricity.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention generally relates to electrical energy generation and, more particularly, to a system for generating electricity from the potential energy of a suspended counterweight.

Currently, fossil fuels or hydrocarbons are the main source of fuel for electrical energy generation. However, these fuels are non-renewable and their supply can be ultimately exhausted. Also, the burning of fossil fuels produces unwanted byproducts such as sulfur dioxide, carbon dioxide, and oxides of nitrogen. Scientists have proven that such byproducts are hazardous to the environment as well as to human health. Thus, in attempts to conserve the limited supply of non-renewable fossil fuels, alternative energy sources are being developed. However, such alternative energy sources have not met with widespread acceptance because of their complexity and associated high costs. For example, solar power is a clean source of electricity essentially producing no pollutants. However, solar power electricity generation systems are typically very expensive to build and maintain. Such large costs of solar power systems are therefore often prohibitive. Also, the effectiveness of solar power systems is highly dependent on the availability of sunlight and thus is a feasible source of energy only in locations having a compatible climate

Geothermal energy is a relatively clean and low cost source of energy that has been in production for quite some time. Technology has been undergoing continuous development in order to more effectively exploit geothermal energy such that it is more economical and efficient in the production of electricity. However, the main drawback to geothermal energy is that it is dependent upon geographical location and, thus, it is not readily available throughout the world. Hydroelectric power plants produce energy by harnessing the power of rivers and other waterways. Although many hydroelectric power plants have been built throughout all parts of the world, this type of energy production unfortunately has significant detrimental environmental impacts. Construction of new dams and power generating facilities face prohibitively complex and costly governmental regulations with the recent effect of a curtailment in the building of hydroelectric power plants.

Energy producers also use windmills and other wind-powered devices to harness the power of the wind. Interest in generating electricity using the power of the wind recently reached its peak. However, it is still not a significant source of energy, mainly because of the inconsistency of the wind and the need to store the electricity produced therefrom until there is a sufficient demand. In addition to the above-mentioned sources of alternative energy, nuclear power is also use for the generation of electricity. However, nuclear power generation results in radioactive nuclear waste as a by product. The disposal of such byproducts has proven to be controversial and expensive. Similarly, even the production of electricity from fossil fuels is harmful to the environment because of the waste and smog produced by the burning of hydrocarbons

Currently, the government offers may incentives for utilizing efficient energy equipment based on proven energy cost savings subject to meeting certain minimum energy efficiency requirements. For example, rebates are offered by the government to help offset the cost of new high-efficiency equipment. In addition, the government offers cash rebates on development of environmentally friendly electric generating equipment, including microturbines and internal combustion generators.

Thus, there exists a need in the art for an electricity generation system that is configured to produce energy in a clean and efficient manner and yet does not further deplete the diminishing source of hydrocarbon-based fuels.

### BRIEF SUMMARY OF THE INVENTION

The present invention specifically addresses and alleviates the above referenced deficiencies associated with the generation of electricity. More particularly, the present invention is an electricity generation system configured for generating electrical energy from potential energy of a suspended counterweight.

All inhabitable structures in the United States either currently include, or must include after completion, an approved permitted electrically wired system. For purposes of this discussion, the electricity generation system of the present invention may be configured in a wide range of sizes adapted for powering a wide range of inhabitable structures that may include residences, restaurants, commercial facilities and factories. It should also be noted that multiple 100 kilowatt (kW) versions of the present invention may be ganged in rows to create a power plant. The electricity generation system of the present invention as included in a residential example of an inhabitable structure would utilize less than 0.5 kW power input from the local electrical utility provider, capitalizing on a 10 kW power output. The aforementioned power gain and cost savings would give users of the present invention the opportunity to receive monetary rewards under a reverse metering program. The reverse metering program is currently provided by some utilities for users of solar and wind power. In addition, electric utility companies offer proportional investment credits towards the purchase of alternative energy saving systems, such as the electricity generation system of the present invention.

The proposed invention provides the dynamic ability to reduce the need for imported oil, virtually eliminating the high demand for heating oil. Such high demand for heating oil and the high cost thereof is especially significant in colder Eastern and Northeastern regions of the United States. An unfortunate side effect regarding the high use of heating oil in such cold regions is the environmental problems associated with leaking heating oil tanks. The electricity generation system of the present invention would greatly reduce the need for diesel fuel-powered electricity generation as well as jet fuel-powered electricity generation.

In addition, the present invention may potentially reduce the loss of human life caused by extreme cold and hot weather conditions by providing affordable heating and air conditioning for everyone. A further benefit of the present invention is that implementation thereof would not require an environmental impact study. The present invention would also be exempt from local air quality management district provisions. Another benefit of the present invention is that it would fuel the economy by allowing energy-savings dollars to be applied toward consumer purchasing. Finally, the present invention would be of low cost in that it utilizes existing technology.

Advantageously, the electricity generation system of the present invention utilizes gravity—the greatest force on this planet and a force that can never be depleted nor be deemed obsolete. Included in the electricity generation system is a multiple pulley system, an actuator, the counterweight, a hydraulic assembly, an elevating motor and a support frame. A pneumatic assembly may be substituted for the hydraulic assembly. The support frame includes a base that may be configured as a flat rectangular plate. The support frame includes four vertical beams disposed on the base at respective corners thereof.

The vertical beams may be interconnected with overhead beams extending between the vertical beams at an upper portion of the support frame. The base, the vertical beams, and the overhead beams may be fabricated of metallic material and may be joined by suitable means such as welding and the like. Collectively, the base, the vertical beam and overhead beams form the rigid support frame for mounting the above-mentioned components. The actuator of the electricity generation system includes a cylinder and a piston rod. The cylinder may have upper and lower ends and a hollow interior chamber open on the upper end and closed on the lower end. The lower end is affixed to the base. The piston rod extends outwardly from the upper end of the cylinder and may be sized to provide a close tolerance fit within the interior chamber such that hydraulic fluid may be pumped through the actuator with minimal leakage of hydraulic fluid between the piston rod and the interior chamber.

The piston rod is slidable within the interior chamber such that the piston rod reciprocates between a first level and a second level. The first level is located at the lower end of the cylinder while the second level is located at the upper end of the cylinder. The actuator alternately draws hydraulic fluid within the interior chamber through the lower end as the piston rod moves from the first level to the second level. The actuator also forces hydraulic fluid out of the interior chamber through the lower end as the piston rod moves from the second level to the first level. Due to the constant reciprocating motion of the piston rod, hydraulic fluid is cyclically pumped into and out of the interior chamber in order to circulate hydraulic fluid through the hydraulic assembly. In configurations where the pneumatic assembly is utilized instead of the hydraulic assembly, pressurized air is pumped through the actuator and circulated through the pneumatic assembly. Thus, for purposes of this discussion, it should be noted that references to the use of hydraulic assembly and the circulation of hydraulic fluid therethrough are interchangeable with the reference to the use of the pneumatic assembly and the circulation of pressurized air through the pneumatic assembly.

The counterweight has a predetermined mass that is sized to provide the appropriate compressive force to the hydraulic fluid such that a sufficient amount of hydraulic fluid may be pumped through the interior chamber. The counterweight may be formed of high-density steel. The support frame may include a guide channel formed of a pair of parallel guide bars on respective sides of the support frame. A guide post may be attached to a side of the counterweight and may be slidable within the corresponding guide channel.

The hydraulic assembly is comprised of an accumulator, a hydraulic turbine, and a generator. The accumulator receives and stores the hydraulic fluid from the cylinder, releasing the hydraulic fluid upon reaching a predetermined pressurization level. The accumulator provides a substantially constant flow of pressurized hydraulic fluid to the hydraulic assembly to compensate for lulls in the pressurization of the hydraulic fluid within the cylinder as the piston rod is moving upwardly from the first level to the second level. The hydraulic turbine receives the pressurized hydraulic fluid from the accumulator, converting the energy of the pressurized hydraulic fluid into mechanical energy of a rotating shaft of the hydraulic turbine. The generator is mechanically connected to the hydraulic turbine such as via a drive belt such that the generator is rotatably driven by the hydraulic turbine at a proportional speed. The generator converts its rotational motion into electricity. As noted above, the same components listed above of the hydraulic assembly may be utilized for circulating pressurized air within a pneumatic assembly.

Also included is the multiple pulley system disposed between the counterweight and the upper portion of the support frame. The multiple pulley system is configured for providing a mechanical advantage for lifting the counterweight and, hence, the piston rod. The multiple pulley system is comprised of a pair of support frame pulleys mounted on the support frame, a pair of counterweight pulleys mounted on the counterweight, and a coupling line reeved through the counterweight pulleys and the support frame pulleys.

Mounted adjacent the actuator is the elevating motor, which is configured to alternately raise and lower the counterweight by intermittently winding up and paying out the coupling line. The counterweight is raised to the second level which simultaneously extends the piston rod upwardly out of the interior chamber. Upon reaching the second level, the elevating motor reverses rotation, with the force of gravity pulling the counterweight downwardly toward the first level. Once the counterweight reaches the first level, the cycle is repeated such that the piston rod is reciprocated within the interior chamber.

A motor controller regulates the operation of the elevating motor, intermittently providing power to the elevating motor when the counterweight is raised toward the second level and shutting off the power to the elevating motor when the counterweight falls toward the first level. The cycle is repeated such that the piston rod is reciprocated within the interior chamber, alternately drawing hydraulic fluid into the interior chamber as the piston rod moves upwardly, extending out of the cylinder, then forcing hydraulic fluid out of the interior chamber as the piston rods moves downwardly, retracting into the cylinder. The reciprocating motion of the piston rod acts to pump hydraulic fluid through the hydraulic assembly to ultimately rotate the generator in order to produce electricity. In configurations utilizing a pneumatic assembly, pressurized air is pumped therethrough.

Importantly, the electricity generation system of the present invention may be configured in a number of various size units adapted to produce proportional quantities of electricity. It will be recognized by those skilled in the art that units of the electricity generation system may be ganged together to produce electricity at rates equivalent to that produced by existing power plants. Thus, such ganged units of the electricity generation systems may serve as an emergency backup source of power when a power plant is placed offline for maintenance, during periods of high power demands, or in case of a power plant malfunction.

### BRIEF DESCRIPTION OF THE DRAWINGS

These as well as other features of the present invention will become more apparent upon reference to the drawings wherein:

FIG. 1 is a side elevational view of an electricity generation system illustrating the structural arrangement of a multiple pulley system, an actuator, a counterweight, a hydraulic assembly, and an elevating motor disposed within a support frame in a first embodiment of the present invention;

FIG. 2 is a front elevational view taken along line 2-2 of FIG. 1 illustrating the arrangement of a piston rod and a cylinder that make up the actuator;

FIG. 3 is a partial side view taken along line 3-3 of FIG. 2 illustrating a guide post disposed within a guide channel of the support frame; and

FIG. 4 is side elevational view of the electricity generation system illustrating gas springs disposed adjacent the actuator.

### DETAILED DESCRIPTION OF THE INVENTION

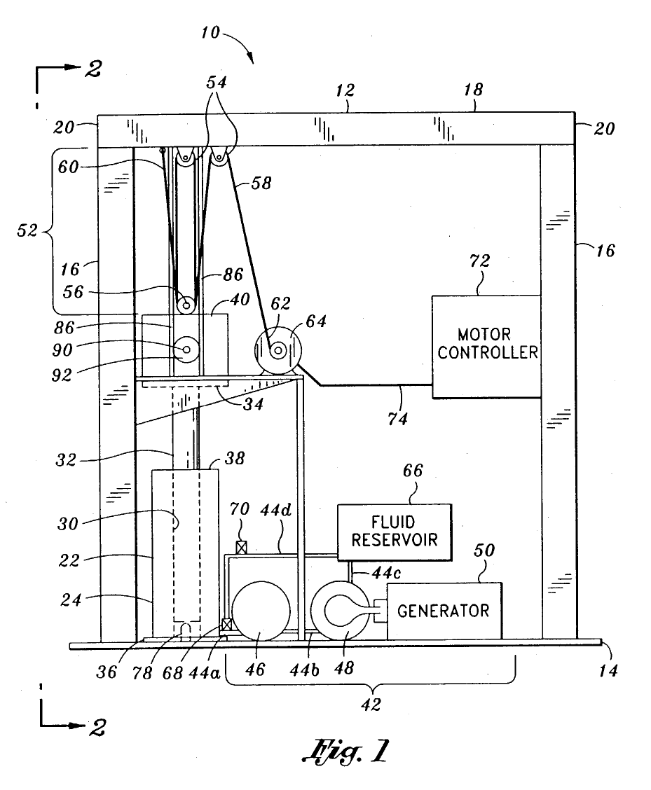

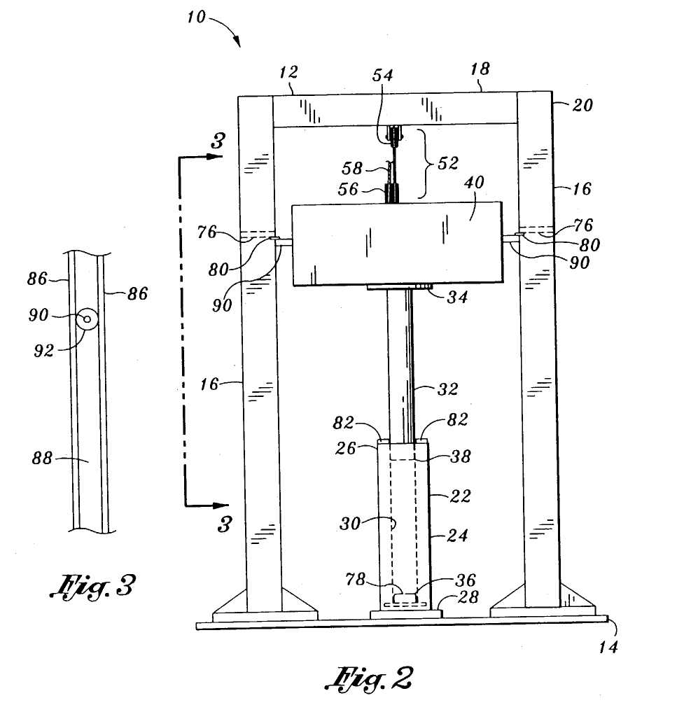

Referring now to the drawings where the showings are for purposes of illustrating the present invention and not for purposes of limiting the same, FIG. 1 illustrates the electricity generation system 10 in a first embodiment. Shown in FIGS. 1 and 2 is the structural arrangement of a multiple pulley system 52, an actuator 22, a counterweight 40, a hydraulic assembly 42, an elevating motor 64 and a support frame 12 that make up the electricity generation system 10. The electricity generation system 10 is configured to generate electrical energy from potential energy of the suspended counterweight 40. The support frame 12 includes a base 14 that may be configured as a flat rectangular plate although the base 14 may be configured in any number of shapes and sizes. The support frame 12 may include four elongate vertical beams 16 disposed on the base 14 at respective corners thereof.

The vertical beams 16 may be interconnected with horizontally disposed, elongate, overhead beams 18 extending between the vertical beams 16 at an upper portion 20 of the support frame 12. The base 14, the vertical beams 16, and the overhead beams 18 may be fabricated of metallic material having favorable strength and stiffness characteristics and may be joined by suitable means such as welding and the like. Collectively, the base 14, the vertical beams 16, and overhead beams 18 form the rigid support frame 12 having the capability for mounting the above-mentioned elements of the electricity generation system 10.

Optionally, the base 14, the vertical beams 16, and the overhead beams 18 may be joined by mechanical fasters such that the support frame 12 may be easily assembled and disassembled to enhance its portability and storability. Although shown in FIGS. 1 and 2 as being a generally orthogonally-shaped structure, it is contemplated that the support frame 12 may be configured in any shape that provides the necessary stiffness and strength to support the working elements of the electricity generation system 10. For example, the support frame 12 may be configured in a triangular shape including two vertical members 16 and two diagonally disposed members. The vertical members 16 and the diagonal members may extend upwardly from the respective corners of the base 14 and may be joined to form an apex. An overhead member may extend horizontally across respective apexes of the triangular frames. Diagonal bracing may be included to provide lateral stability for the support frame 12.

The actuator 22 of the electricity generation system 10 includes an elongate cylinder 24 and an elongate piston rod 32. The cylinder 24 may have upper and lower ends 26, 28 and a hollow interior chamber 30 open on the upper end 26 and closed on the lower end 28. The lower end 28 is affixed to the base 14 as can be seen in FIG. 1. The piston rod 32 extends outwardly from the upper end 26 of the cylinder 24 and may be sized and configured complimentary to that of the cylinder 24. In this regard, the interior chamber 30 may be configured in a cylindrical shape with the piston rod 32 also being configured in a cylindrical shape.

The piston rod 32 may be sized to provide a close tolerance fit within the interior chamber 30 such that hydraulic fluid may be pumped through the actuator 22 minimizing leakage of the hydraulic fluid between the piston rod 32 and the interior chamber 30. A pneumatic assembly (not shown) may be utilized instead of the hydraulic assembly. In such configurations, pressurized air is pumped through the actuator and circulated through the pneumatic assembly. Thus, it is recognized herein for purposes of this discussion that references to the use of the hydraulic assembly and the circulation of hydraulic fluid in the electricity generation system 10 are interchangeable with the pneumatic assembly and the circulation of pressurized air therethrough.

Optionally, a flexible ring seal (not shown) may be attached to the piston rod 32, the ring seal slidably disposed between the piston rod 32 and interior chamber 30 in order to provide a barrier to hydraulic fluid leakage. A bumper 78 may be disposed within the interior chamber 30 at the lower end 28 to absorb the impact of the piston rod 32 as it nears the end of its downward travel. The piston rod 32 and cylinder 24 may be preferably configured to allow about thirty inches of travel of the piston rod 32 within the interior chamber 30 as the piston rod 32 moves between a first level 36 and a second level 38.

The piston rod 32 is axially slidable within the interior chamber 30 such that the piston rod 32 may freely reciprocate between the first level 36 and the second level 38. The first level 36 is located adjacent the lower end 28 of the cylinder 24. The second level 38 is located adjacent the upper end 26 of the cylinder 24. As will be explained in further detail below, the actuator 22 operates to alternately draw hydraulic fluid within the interior chamber 30 through the lower end 28 as the piston rod 32 extends from the first level 36 to the second level 38. Optionally, pressurized air may be utilized in the electricity generation system with the pneumatic assembly circulating the pressurized air therethrough. The actuator 22 also operates to force the hydraulic fluid out of the interior chamber 30 through the lower end 28 as the piston rod 32 retracts from the second level 38 to the first level 36. Due to the constant reciprocating motion of the piston rod 32, hydraulic fluid is cyclically pumped into and out of the interior chamber 30 in order to circulate hydraulic fluid through the hydraulic assembly 42, as will be explained in more detail below.

The electricity generation system 10 includes the counterweight 40 having a predetermined mass that is sized to provide the appropriate motive force to the piston rod 32 such that a sufficient amount of hydraulic fluid may be pumped through the interior chamber 30 and, hence, through the hydraulic assembly 42. Alternatively, counterweight 40 may be mounted on a platform 34 connected to the piston rod 32, as can be seen in FIG. 1. The counterweight may be formed of high-density steel. By including the platform 34 in the electricity generation system 10, counterweights of varying mass may be readily substituted in order to accommodate varying power output requirements for the electricity generation system 10. The platform 34 may be attached to the piston rod 32 by suitable means such as by welding, or with mechanical fasters. The counterweight 40 may be attached to the platform 34, if included, by mechanical fasteners or other suitable means.

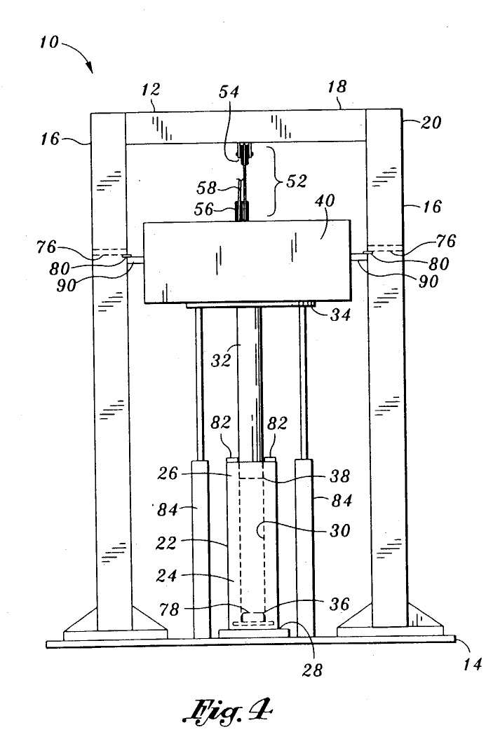

Turning briefly now to FIG. 3, the support frame 12 may include at least one vertically oriented guide channel 88 formed of a pair of parallel, spaced-apart guide bars 86 disposed within the support frame 12 adjacent the counterweight 40. The pair of the guide bars 86 may be disposed on respective sides of the support frame 12. A guide post 90 may be attached to a side of the counterweight 40 and may be sized and configured complimentary to and slidably disposed within the corresponding guide channel 88, as can be seen in FIG. 3. Optionally, a guide roller 92 may be provided instead of the guide post 90 in order to eliminate frictional losses that may be inherent with the sliding resistance of guide posts 90 against the guide channel 88. However, the combination of guide posts 90 and guide bars 86 may be omitted and a plurality of actuators may instead be incorporated into the electricity generation system 10 in order to provide stability for the moving counterweight 40. Such an arrangement is discussed in more detail below.

The hydraulic assembly 42 of the electricity generation system 10 is disposed adjacent the base 14 and is configured for circulating hydraulic fluid therethrough. As was noted above, the pneumatic assembly may be substituted for the hydraulic assembly. If the pneumatic assembly is utilized in the electricity generation system 10 instead of the hydraulic assembly, then pressurized air will also be substituted as the working fluid. The hydraulic assembly 42 is comprised of an accumulator 46, a hydraulic turbine 48, and a generator 50. The accumulator 46 is fluidly connected to the interior chamber 30 via feedline 44a and is configured to receive the hydraulic fluid therefrom. Disposed adjacent the lower end 28 of the cylinder 24, the accumulator 46 stores the hydraulic fluid and releases the hydraulic fluid once the hydraulic fluid reaches a predetermined pressurization level.

Because the actuator 22 provides hydraulic fluid to the accumulator 46 only when the piston rod 32 is retracting and not when the piston rod 32 is extending, the accumulator 46 provides a substantially constant flow of pressurized hydraulic fluid to the hydraulic assembly 42 to compensate for lulls in the pressurization of the hydraulic fluid within the cylinder 24 as the piston rod 32 is moving upwardly from the first level 36 to the second level 38. The accumulator 46 may be configured to provide the additional benefit of maintaining pressure of the hydraulic fluid within the hydraulic assembly 42 in order to compensate for pressure losses due to leakage in connecting fittings. Furthermore, the accumulator 46 may be configured to compensate for increases in pressure due to thermal expansion of the hydraulic fluid within the hydraulic assembly 42.

Also included within the hydraulic assembly 42 is the hydraulic turbine 48, shown in FIG. 1, disposed adjacent to the accumulator 46 at the base 14 of the support frame 12. The hydraulic turbine 48 is fluidly connected to the accumulator 46 via feedline 44b and receives the pressurized hydraulic fluid from the accumulator 46. The hydraulic turbine 48 is configured to convert the energy of the pressurized hydraulic fluid into mechanical energy of a rotating shaft of the hydraulic turbine 48. Because the accumulator 46 is configured to deliver hydraulic fluid at a substantially constant level of pressurization, the hydraulic turbine 48 may be rotated at a substantially constant speed.

The generator 50 is mechanically connected to the hydraulic turbine 48 such as via a drive belt (not shown). The drive belt connects drive wheels (not shown) mounted on respective shafts (not shown) of the generator 50 and the hydraulic turbine 48. In this manner, the generator 50 may be rotatably driven by the hydraulic turbine 48 at a proportional speed, depending on the relative sizes of the respective drive wheels of the hydraulic turbine 48 and the generator 50. Thus, the generator 50 may be configured to rotate at the same speed as the hydraulic turbine 48. Alternatively, the generator 50 may be configured to rotate either faster or slower than that of the hydraulic turbine 48. It is herein recognized that there are many configurations that may be utilized for mechanically connecting the generator 50 to the hydraulic turbine 48. For example, the generator 50 may be coaxially attached to the shaft of the hydraulic turbine 48 with a clutch being interposed therebetween such that the hydraulic turbine 48 may commence rotation once the hydraulic turbine 48 reaches a predetermined rotational velocity.

Regardless of the manner in which the generator 50 is mechanically connected to the hydraulic turbine 48, the generator 50 is configured to convert rotational motion to electricity. Operating in a manner similar to that of a conventional generator, the generator 50 of the present invention may include a number of spinning conductors mounted on an armature. The armature is rotated in a magnetic field produced by field coils disposed within the generator 50. A battery (not shown) may be included within the hydraulic assembly 42 and may be electrically connected to the generator 50. The battery may be disposed adjacent the generator 50 and may be configured to store electricity produced thereby. The combination of the generator 50 and the battery may be collectively configured to supply power to an electrical device during periods of high demand.

A fluid reservoir 66 may be included within the hydraulic assembly 42, as is illustrated in FIG. 1. The fluid reservoir 66 is shown fluidly connected to the hydraulic turbine 48 via feed line 44c. The fluid reservoir 66 is also fluidly connected to the lower end 28 of the cylinder 24 via feed line 44d. Configured for storing the hydraulic fluid flowing thereinto from the hydraulic turbine 48, the fluid reservoir 66 is configured to release hydraulic fluid to the cylinder 24 at the lower end 28 when the extension of the piston rod 32 out of the interior chamber 30 acts to draw hydraulic fluid into the interior chamber 30. The hydraulic assembly 42 may further include a first check valve 68 fluidly connected to and interposed between the lower end 28 and the accumulator 46 within feed line 44a.

The first check valve 68 may be oriented to block the flow of hydraulic fluid from the accumulator 46 towards the lower end 28. A second check valve 70 may also be included with the hydraulic assembly 42 and may be fluidly connected to and interposed between the fluid reservoir 66 and the lower end 28 of the cylinder 24. The second check valve 70 may be oriented to block the flow of hydraulic fluid from the lower end 28 towards the fluid reservoir 66. By orienting the first check valve 68 and second check valve 70 in this manner, the hydraulic fluid may circulate through the hydraulic assembly 42 in one direction only, which in FIG. 1 is in the counter-clockwise direction. It is herein recognized that the same components comprising the hydraulic assembly may be utilized for circulating pressurized air within the pneumatic assembly.

As can be seen in FIG. 1, the electricity generation system 10 advantageously includes the multiple pulley system 52 disposed between the counterweight 40 and the upper portion 20 of the support frame 12. The multiple pulley system 52 is configured for moving the counterweight 40 and, hence, the piston rod 32 towards the upper portion 20 of the support frame 12 from the first level 36 to the second level 38 with a mechanical advantage. The mechanical advantage provided by the multiple pulley system 52 is such that the force required to raise the counterweight 40 may be reduced compared to an arrangement wherein the total mass of the counterweight 40 is totally supported by a single oppositely applied force.

The multiple pulley system 52 is comprised of a pair of independently rotating support frame pulleys 54, a pair of independently rotating counterweight pulleys 56, and a coupling line 58 fabricated from rope or cable. The support frame pulleys 54 are rotatably mounted on the upper portion 20 of the support frame 12. The counterweight pulleys 56 are rotatably mounted on the counterweight 40. The coupling line 58 has first and second ends 60, 62 with the first end 60 being attached to the upper portion 20 of the support frame 12 as can be seen in FIGS. 1 and 2. The coupling line 58 is reeved through the counterweight pulleys 56 and the support frame pulleys 54.

The multiple pulley system 52 shown in FIGS. 1 and 2 is substantially vertically oriented, the arrangement shown providing a mechanical advantage of about 4:1 wherein the total mass of the counterweight 40 is equally supported by respective sections of the coupling line 58 that are reeved through the counterweight pulleys 56 and support frame pulleys 54. In the arrangement shown, the counterweight 40 may have a mass of about 160 pounds. With a 4:1 mechanical advantage provided by the multiple pulley system 52, respective sections of the coupling line 58 will each carry about 40 pounds in order to statically support the 160-pound counterweight 40. However, approximately four times the length of coupling line 58 must be reeled in to raise the counterweight 40 over a given distance as compared to an arrangement where the counterweight 40 is directly lifted without the aid of the multiple pulley system 52. Although the multiple pulley system 52 of the present invention has a preferable 4:1 mechanical advantage as is illustrated in FIG. 1, greater or lower mechanical advantage ratios may be provided by increasing or decreasing the quantity of pulleys.

It should also be noted that although the above description of the multiple pulley system 52 includes pulleys, any rotating member and complimentary coupling line may be utilized. In this regard, it is contemplated that the coupling line 58 may be fabricated from material selected from a group consisting of rope, cable, belt and chain. For example, where the electricity generation system 10 counterweight 40 has a significantly high mass, rotating members such as metallic sprockets may be utilized in conjunction with metallic, non-stretching chain instead of pulleys and a cable. The support frame pulleys 54 and the counterweight pulleys 56 may each be configured in the shape of a sprocket while the coupling line 58 may be fabricated from chain configured to be engageable therewith.

Referring still to FIG. 1, mounted adjacent the actuator 22 is the elevating motor 64. The elevating motor 64 is connected to the second end 62 of the coupling line 58 and is configured to alternately raise and lower the counterweight 40 between the first and second level 38s by intermittently winding up and paying out the coupling line 58, as will be explained in more detail below. In this manner, the counterweight 40 is raised from the first level 36 to the second level 38 which simultaneously extends the piston rod 32 upwardly out of the interior chamber 30. Upon reaching the second level 38, the coupling line 58 is allowed to reverse rotation, with the force of gravity pulling the counterweight 40 downwardly toward the first level 36. A free-wheeling feature may be incorporated into the elevating motor 64 to allow the counterweight 40 to freely fall from the second level 38 to the first level 36. Once the counterweight 40 reaches the first level 36, the cycle is repeated such that the piston rod 32 is reciprocated within the interior chamber 30. In this manner, the hydraulic fluid may be circulated through the hydraulic assembly 42. If the pneumatic assembly is utilized, pressurized air may be circulated therethrough.

A motor controller 72 may be included with the electricity generation system 10, as is illustrated in FIG. 1. The motor controller 72 is electrically connected to the elevating motor 64 via electrical line 74. An upper limit switch 80 and a lower limit switch 82 may also be included with the electricity generation system 10 with the upper and lower limits witches 80, 82 being electrically connected to the motor controller 72. An upper stop 76 may be affixed to the support frame 12 adjacent the second level 38. The upper stop 76 is configured to block the upward movement of the counterweight 40. The first limit switch is disposed adjacent the upper end 26 of the cylinder 24 with the second limit switch disposed adjacent the upper stop 76.

The motor controller 72 may be mounted on the support frame 12 adjacent the elevating motor 64 and may be electrically connected to the elevating motor 64. Configured to regulate the operation of the elevating motor 64, the motor controller 72 intermittently provides power to the elevating motor 64 when the counterweight 40 moves between the first level 36 and the second level 38. During the upward movement of the counterweight 40 between the first level 36 and the second level 38, the motor controller 72 allows the elevating motor 64 to rotate in order to wind up the coupling line 58 at the second end 62 such that the counterweight 40 is moved from the first level 36 to the second level 38.

When the counterweight 40 reaches the upper stop 76 at the second level 38, the upward movement of the counterweight 40 is blocked and the motor controller 72 ceases to provide power to the elevating motor 64, allowing the motor to free-wheel in a reversed rotational direction compared to the winding direction. During its free-wheeling rotational motion, the elevating motor 64 pays out the coupling line 58 as the force of gravity pulls the counterweight 40 downwardly from the second level 38 toward the first level 36. When the counterweight 40 reaches the first level 36, the lower limit switch 82 is activated by the counterweight 40 which then triggers the motor controller 72 to again provide power to the elevating motor 64.

The cycle is repeated such that the piston rod 32 is reciprocated within the interior chamber 30, alternately drawing hydraulic fluid into the interior chamber 30 as the piston rod 32 moves upwardly, extending out of the cylinder 24, then forcing hydraulic fluid out of the interior chamber 30 as the piston rod 32 moves downwardly, retracting into the cylinder 24. As will be explained in more detail below, the reciprocating motion of the piston rod 32 acts to pump hydraulic fluid through the hydraulic assembly 42 to ultimately rotate the generator 50 in order to produce electricity. It is contemplated that the elevating motor 64 may be solar powered wherein photovoltaic cells may be mounted on the support frame 12 to power the elevating motor 64. It should be noted that the elevating motor is not limited to an electrically powered motor. Optionally, the elevating motor may be a hydraulic or pneumatic motor or spindle configured to alternately raise and lower the counterweight. The elevating motor 64 is preferably rated at ¼ horsepower, which is estimated to be sufficient for raising the counterweight 40 having a preferred mass of 160 pounds.

Optionally, the electricity generation system 10 may further include at least one gas spring 84, although a pair of gas springs 84 may be included on respective sides of the actuator 22, as is illustrated in FIG. 4. The gas spring 84 is disposed between the base 14 and the counterweight 40 and is configured for raising the counterweight 40 in cooperation with the elevating motor 64. The gas spring 84 may be a self-contained unit comprised of a piston slidably disposed within a cylinder filled with high-pressure gas such as nitrogen gas. The gas spring 84 is configured to provide an upward force against the counterweight 40 to assist the elevating motor 64 in raising the counterweight 40 from the first level 36 to the second level 38.

Advantageously, the gas spring 84 is configured such that the upward force produced thereby is greater than the force required to compress the gas spring 84 as the counterweight 40 moves downwardly from the second level 38 to the first level 36. A damping effect may also be provided by the gas spring 84 as it nears the end of its compression stroke, thus minimizing wear and tear on the actuator 22 during the cyclic operation thereof. The opening and closing speed of the gas spring 84 may be varied by adjusting a metering orifice (not shown) disposed on the gas spring 84. By including the gas spring 84, the cycle time in moving the piston rod 32 from the first level 36 upwardly toward the second level 38 may be reduced.

In a second embodiment, the actuator 22 may be comprised of first, second and third elongate cylinders (not shown) each having an upper end and a lower end and a hollow interior chamber open on the upper end and closed on the lower end. The lower end of respective ones of the first, second and third cylinders may be mounted on the base 14. First, second and third elongate piston rods (not shown) may extend outwardly from the upper end of respective ones of the first, second and third cylinders with the first, second and third piston rods being sized and configured complimentary to and axially slidable within the interior chamber of respective ones of the first, second and third cylinders.

By including the first, second and third cylinders with respective ones of the first, second and third piston rods, the counterweight 40 may be laterally supported without the aid of guide posts 90, guide rollers 92, or guide channels 88 shown in FIG. 3. The first, second and third piston rods each define a cross-sectional area and may be sized and configured such that the cross-sectional area of the first and second piston rods is substantially equal and larger than that of the third piston rod. It should be noted that at least one gas spring 84 may be included in the second embodiment. The gas spring 84 is configured to provide an upward force against the counterweight 40 to assist the elevating motor 64 in raising the counterweight 40 from the first level 36 to the second level 38.

The operation of the electricity generation system 10 of the first embodiment will now be described. Starting with the condition illustrated in FIG. 1 wherein the piston rod 32 is retracted inside the interior chamber 30 at the first level 36. The motor controller 72 initially provides power to the elevating motor 64 such that a shaft of the elevating motor 64 rotates in order to wind up the coupling line 58 at the second end 62. Due to the mechanical advantage provided by the multiple pulley system 52, the elevating motor 64 applies a tensile force that is a fraction of the total mass of the counterweight 40. For a preferable counterweight 40 mass of about 160 pounds, with a 4:1 mechanical advantage of the multiple pulley system 52, the minimum tensile force required to wind in the coupling line 58 at the second end 62 is at least about 40 pounds.

As the elevating motor 64 winds in the coupling line 58, opposite ends of the multiple pulley system 52 are moved vertically relative to one another, raising the counterweight 40. Simultaneously, the guide posts 90 and the guide rollers 92 laterally stabilize the counterweight 40 as the guide rollers 92 slide inside the guide channel 88 between the spaced pair of guide bars 86 on respective sides of the support frame 12. The gas spring 84 provides an additional upward force to assist the elevating motor 64 in raising the counterweight 40 from the first level 36 to the second level 38.

The piston rod 32, attached to the counterweight 40, is drawn upwardly from the lower end 28 of the interior chamber 30 from the first level 36 to the second level 38. Because the piston rod 32 is slidably sealed within the interior chamber 30, a vacuum pull is created in the interior chamber 30 as the piston rod 32 moves away from the lower end 28, drawing hydraulic fluid into the interior chamber 30 from the fluid reservoir 66 of the hydraulic assembly 42 through feed line 44a. The counterweight 40 continues its upward movement toward the second level 38, continuously drawing hydraulic fluid into the interior chamber 30 until the guide posts 90 contact the upper stops 76.

When the guide posts 90 contact the upper stops 76, the upper limit switch 80 is activated, triggering the motor controller 72 to halt the supply of power to the elevating motor 64 such that the elevating motor 64 ceases to rotate. When the elevating motor 64 ceases to wind in the coupling line 58 after the counterweight 40 reaches the second level 38, the free-wheeling feature of the elevating motor 64 engages allowing the shaft thereof to reverse rotational direction, paying out the coupling line 58 and allowing opposite ends of the multiple pulley system 52 to move away from one another and ultimately, allowing the counterweight 40 to move downwardly towards the first level 36.

Laterally stabilized by the guide posts 90 sliding within the guide channels 88, the counterweight 40 moves from the second level 38 downwardly towards the first level 36. If guide posts 90 and guide channels 88 are not included, first, second and third piston rods disposed within respective ones of the first, second and third cylinders provides the necessary lateral stability for the counterweight 40 as it moves between the first and second levels 36, 38. The piston rod 32 is retracted into the interior chamber 30 during its downward movement, forcing the hydraulic fluid out of the lower end 28 and into the accumulator 46 of the hydraulic system through feed line 44a.

When the piston rod 32 contacts the bumper 78 at the lower end 28 of the interior chamber 30, the lower limit switch 82 is simultaneously contacted, triggering the motor controller 72 to again provide power to the elevating motor 64 to wind in the second end 62 of the coupling line 58 so that the counterweight 40 is again raised from the first level 36 to the second level 38. As the fluid is forced out of the lower end 28 of the interior chamber 30 and into the accumulator 46, the first check valve 68 prevents the back flow of the hydraulic fluid from the accumulator 46 into the interior chamber 30 under vacuum pressure as the piston rod 32 is drawn upwardly from the first level 36 to the second level 38. The piston rod 32 is reciprocated inside the interior chamber 30, effectively pumping fluid under increasing pressure into the accumulator 46.

Once the hydraulic fluid inside the accumulator 46 reaches a predetermined pressurization level, the accumulator 46 releases the pressurized hydraulic fluid to the hydraulic turbine 48 via the feedline 44b, causing the shaft of the hydraulic turbine 48 to rotate. Because the accumulator 46 is configured to deliver hydraulic fluid at a substantially constant level of pressurization, the hydraulic turbine 48 may be rotated at a substantially constant speed. Due to the mechanical connection of the respective shafts of the generator 50 and the hydraulic turbine 48, the generator 50 is rotatably driven by hydraulic turbine 48 at a proportional speed, depending on the relative sizes of respective drive wheels mounted on the respective shafts of the hydraulic turbine 48 and the generator 50. The generator 50 convents the rotation motion into electricity. If included, the battery stores electricity produced by the generator 50 such that sufficient power may be provided to an electrical device during periods of high demand.

In the first embodiment wherein the counterweight 40 has a mass of about 160 pounds, the multiple pulley system 52 provides a mechanical advantage of about 4:1, the elevating motor 64 produces about ¼ horsepower, and the diameter of the piston rod 32 and cylinder 24 is about 3.25 inches with a travel of about 30 inches, it is estimated that the electricity generation system 10 may be configured to produce about 10,000 watts of electricity. In such a configuration, it is further estimated that the total retraction time of the piston rod 32 in moving upwardly from the first level 36 to the second level 38 is about 5 seconds at a rate of about 6 inches per second. The addition of gas springs 84 of the second embodiment may reduce the retraction time of the piston rod 32, ultimately increasing the power output of the generator 50.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. An electricity generation system for generating electrical energy from potential energy, the system comprising:
a support frame having a base and an upper portion;
an actuator for pumping hydraulic fluid therethrough, the actuator comprising:
an elongate cylinder having upper and lower ends and a hollow interior chamber open on the upper end and closed on the lower end, the lower end being mounted on the base; and
an elongate piston rod extending outwardly from the upper end and being sized and configured complimentary to and axially slidable within the interior chamber between a first level and a second level;
a counterweight of a predetermined mass attached to the piston rod above the upper end;
a hydraulic assembly mounted on the base for circulating the hydraulic fluid therethrough, the hydraulic assembly comprising:
an accumulator fluidly connected to the lower end and being configured to receive the hydraulic fluid therefrom and release the hydraulic fluid at a prescribed pressure level;
a hydraulic turbine fluidly connected to the accumulator and being configured to receive the pressurized hydraulic fluid therefrom such that the hydraulic turbine may be rotated; and
a generator mechanically connected to and rotatably driven by the hydraulic turbine and being configured to convert rotational motion into electricity;
a multiple pulley system configured for moving the counterweight towards the upper portion, the multiple pulley system comprising:
a pair of support frame pulleys rotatably mounted on the upper portion;
a pair of counterweight pulleys rotatably mounted on the counterweight; and
a coupling line having first and second ends, the first end being connected to the upper portion, the coupling line being reeved through the counterweight pulleys and the support frame pulleys; and
an elevating motor mounted on the support frame and connected to the second end, the elevating motor being configured to alternately raise and lower the counterweight between the first and second levels by intermittently winding up and paying out the coupling line to reciprocate the piston rod within the interior chamber such that the hydraulic fluid may be circulated through the hydraulic assembly.

2. The electricity generation system of claim 1 wherein the hydraulic assembly further comprises a fluid reservoir fluidly connected between the hydraulic turbine and the lower end, the fluid reservoir being configured for storing the hydraulic fluid.

3. The electricity generation system of claim 2 wherein the hydraulic assembly further comprises a first check valve fluidly connected between the lower end and the accumulator and being oriented to block the flow of hydraulic fluid toward the lower end.

4. The electricity generation system of claim 2 wherein the hydraulic assembly further comprises a second check valve fluidly connected between the fluid reservoir and the lower end and being oriented to block the flow of hydraulic fluid toward the fluid reservoir.

5. The electricity generation system of claim 1 further comprising a motor controller mounted on the support frame and electrically connected to the elevating motor, the motor controller being configured to regulate the operation of the elevating motor.

6. The electricity generation system of claim 1 wherein the elevating motor is solar powered.

7. The electricity generation system of claim 1 further comprising a battery electrically connected to the generator and being configured for storing electricity produced thereby.

8. The electricity generation system of claim 1 further comprising:
a gas spring disposed between the base and the counterweight;
wherein the gas spring is configured to raise the counterweight in cooperation with the elevating motor.

9. The electricity generation system of claim 1 wherein the actuator comprises:
first, second and third elongate cylinders each having upper and lower ends and a hollow interior chamber open on the upper end and closed on the lower end, the lower end of respective ones of the first, second and third cylinders being mounted on the base; and
first, second and third elongate piston rods extending outwardly from the upper end of respective ones of the first, second and third cylinders, the first, second and third piston rods being sized and configured complimentary to and axially slidable within the interior chamber of respective ones of the first, second and third cylinders.

10. The electricity generation system of claim 9 wherein:
the first, second and third piston rods each define a cross-sectional area;
the cross-sectional area of the first and second piston rods being substantially equal and larger than that of the third piston rod.

11. The electricity generation system of claim 1 wherein the coupling line is fabricated from material selected from a group consisting of rope, cable, belt, and chain.

12. The electricity generation system of claim 11 wherein:
the support frame pulleys and the counterweight pulleys are each configured in the shape of a sprocket;
the coupling line is fabricated from chain configured to be engageable with the support frame pulleys and the counterweight pulleys.

13. The electricity generation system of claim 1 wherein the predetermined mass of the counterweight is approximately 160 pounds.

14. The energy generation system of claim 13 wherein the elevating motor is capable of drawing in the second end of the coupling line at a tension load of about 40 pounds.

15. The electricity generation system of claim 1 further comprising:
at least one vertically oriented guide channel formed within the support frame adjacent the counterweight; and
at least one guide post rotatably attached to a side of the counterweight and being sized and configured complimentary to and slidably disposed within the corresponding guide channel.
